(19) United States
(12) Patent Application Publication
(10) Pub. No.: US 2012/0226571 A1
(43) Pub. Date: Sep. 6, 2012

(54) Product tracking to enable tipping of a producer

(75) Inventor: Nicolas Dmitri Brown, Portland, OR (US)

(73) Assignee: Pachamama Coffee Cooperative, Davis, CA (US)

(21) Appl. No.: 13/385,764

(22) Filed: Mar. 5, 2012

Related U.S. Application Data
(60) Provisional application No. 61/449,471, filed on Mar. 4, 2011.

(51) Int. Cl. G06Q 30/06

(52) U.S. Cl. 705/26.1

(57) ABSTRACT

Provided herein are various techniques for monetarily tipping a producer through product tracking. An exemplary system or method constructed in accordance with techniques described in this paper can generate a computer readable reference code in association with a producer or product, wherein the computer readable reference code (e.g., barcode, image, or alphanumeric character string) once received by a computing device, is configured to cause the computing device to be directed to an interface (e.g., application or web-based interface) through which an individual can send a monetary tip to the producer. After generation, the computer readable reference code may be provided for marking on a product that is associated with the producer.

### BACKGROUND

Generally, manufactured products (e.g., machinery) and grown products (e.g., coffee, fruits, and vegetables) purchased by consumers are either produced by a large corporate organization (i.e., a corporate producer) or a small business organization (i.e., small business producer). Typically, consumer perceive corporate producers as more concerned with high production yield, and less with the personal aspects of manufacturing the product (e.g., a personal connection with or interest in the product they produce). On the other hand, consumers usually regard products by small business producers, such as startups corporations or organizations that are family owned and/or operated, as being produced with personal care and quality.

In some cases, consumers wish to express their satisfaction to a business organization for the products they produce, especially where the business organization expresses personal interest in the quality of their products, as many small businesses do. Unfortunately, beyond sending compliments to the organization for the product, posting great reviews for the product or producer (e.g., on the Internet), or purchasing more products from the producer, there are very few methods by which consumer can express their satisfaction with a product or a producer's. Additionally, because consumers typically purchase products through a retailer or vendor, rather than directly from a producer, there is a general disconnection between the consumer and the producer.

### SUMMARY

Provided herein are various techniques for monetarily tipping a producer through product tracking. Producers may include entities that produce a product for purchase and/or use by a consumer. Products produced may include those that are manufactured, grown, or created by a producer.

An exemplary system or method constructed in accordance with techniques described in this paper can generate a computer readable reference code in association with a producer or product, wherein the computer readable reference code (e.g., barcode, image, or alphanumeric character string) once received by a computing device, is configured to cause the computing device to be directed to an interface (e.g., application or web-based interface) through which an individual can send a monetary tip to the producer. For example, the computer readable reference code may be a QR code containing an ID for the producer, and command to open a specific universal resource locator (URL) to reach a tip interface associated with the producer. After generation, the computer readable reference code may be provided for marking on a product that is associated with the producer. For example, the computer readable reference code may be provided to the producer, so that they can dispose of the computer readable reference code on product packaging.

Once the product is purchased, the consumer may desire to submit a monetary tip to the producer, and may enter the computer readable reference code marked on the product into a computing device. Depending on the technique, the consumer may enter the computer readable reference code by scanning the code (e.g., a barcode, such as QR code) using a computing device (e.g., smartphone or tablet) or by manually entering the code into a website interface (e.g., on their desktop or laptop computer system).

For some implementations, entering the computer readable reference code into the computing device causes the computing device to issue a request to monetarily tip the producer. Upon receiving such a request, a system may provide the requesting computing device with an interface through which the individual can send a monetary tip to the producer. Specifically, through the interface, a consumer may enter information (“tip information”) that will facilitate processing their tip request. For some implementations, the interface may be a web site, through which a consumer may enter such tip information as: a tip amount to be submitted to the producer, a payment method for providing the tip to the producer, and/or enter a comment to the producer. Certain implementations may further permit a consumer to share news of their tip payment and/or express their satisfaction of the product/producer on a social media site such as Facebook or Twitter. The system may receive the tip information from the requesting computing device through the interface and process the tip information, thereby crediting the producer with a monetary tip in accordance with the tip information.

Use of some systems described herein may provide a marketing, differentiation, or branding advantage to participating products, which may lead to increased sales and margins. Depending on the implementation, a producer may be charged a fee or percentage of sales to participate in the technique described herein.

### BRIEF DESCRIPTION OF THE DRAWINGS

FIG. 1 depicts an example of a system for tracking a product to enable tipping of a producer in accordance with some implementations.

FIG. 2 depicts a flowchart of an example of a method for tracking a product to enable tipping of a producer in accordance with some implementations.

FIG. 3 depicts usage of an example of a system for tracking a product to enable tipping of a producer in accordance with some implementations.

FIG. 4 depicts an example of a computer system on which techniques described in this paper can be implemented.

### DETAILED DESCRIPTION

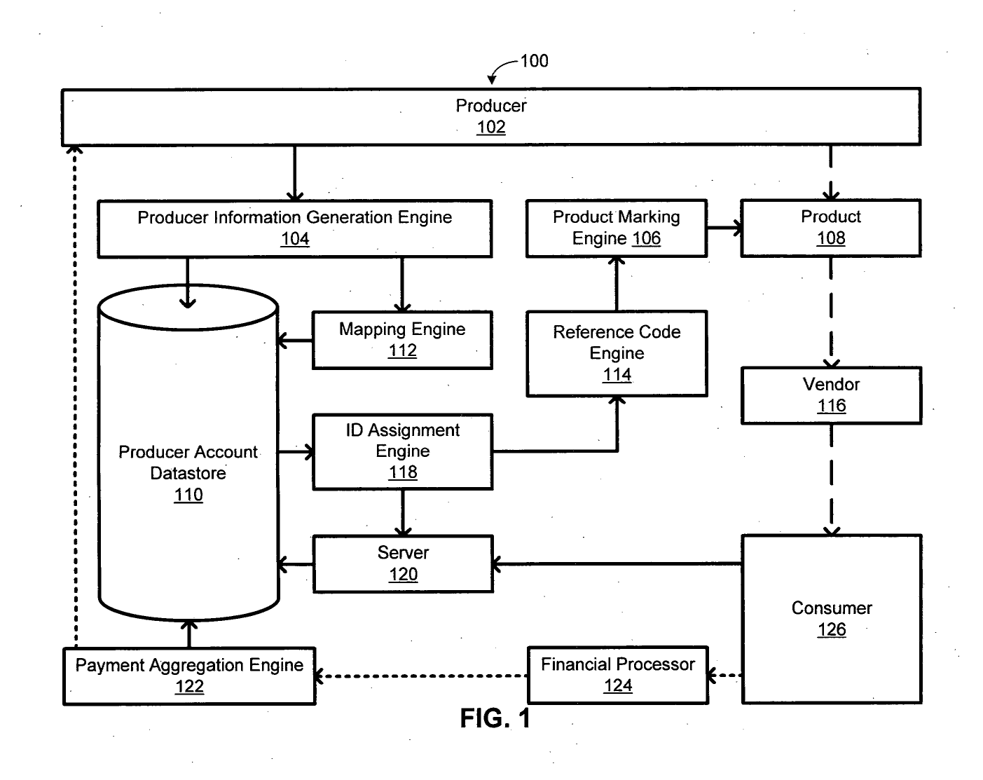

FIG. 1 depicts an example of a system 100 for monetarily tipping a producer through product tracking. The system 100 comprises a producer information generation engine 102, a product marking engine 106, a producer account data store 110, a mapping engine 112, a reference code engine 114, a ID assignment engine 118, a server 120, a payment aggregation engine 122, and a financial processor 124. Parties that may be involved with the system 100 may include the producer 102, the vendor 116, and the consumer 126. The producer 102 (e.g., coffee bean farmer) may produce the product 108 (e.g., coffee bean) to be sold to the consumer 126, the vendor 116 (e.g., grocery store) may provide the product 108, and the consumer 126 may be the ultimate purchaser and user of the product 108. The dashed lines in FIG. 1 represent movement of the product 108 from the producer 102, to the vendor 116, to the consumer 126.

The producer information generation engine 102 may be configured to gather from the producer 102 information regarding the product 108 or information regarding the producer 102 itself. Information gathered from the producer may include the producer's organization type (e.g., co-op), the producer's geographic location, product type (e.g., coffee bean type), product origin (e.g., farm), product source (e.g., co-op, country, region, etc.), or production environment (e.g., altitude, coffee bean, farm size, annual crop, etc.). The information gathered may be categorized and eventually stored in the producer account data store 110, which contains an account associated with the producer 102 and/or their product 108.

The mapping engine 112 may be configured to generate map information or a map from GPS coordinates provided by the producer information generation engine 104 or, alternatively information stored in the producer account datastore 110. For some implementations, the mapping engine 112 may utilize Google Earth, or the like, to generate the map or map information. The map or map information generated may be subsequently stored in the producer account datastore 110.

The ID assignment engine 118 may be configured to generate and assign a identifier (ID) in association with the producer 102 or their product 108. For example, the ID may correspond to the coffee farmer or the coffee bean at some stage after harvesting, roasting, or bagging. In some implementations, an example ID may include an applicable alphanumeric code that identifies the producer 102 or the product 108. For instance, the ID may comprise three letters that correspond to particular a product (e.g., ABC) and four digits that correspond to a particular producer (e.g., 1234). The ID, once produced, may be provided to the server 120 to be organized and stored in the producer account datastore 110 in association with the producer 102 or the product 108.

The reference code engine 114 may be configured to generate and assign a computer readable reference code to the producer 102 or the product 108. Depending on the implementation, the computer readable reference code may include a barcode, an image, or an alphanumeric character string. For example, the reference code engine 114 may generate and assign a QR code to the producer 102 or to the product 108 associated with the producer 102. In addition to ID information, the computer readable reference code may embedded other data, such a command to open a URL (e.g., which may lead to an interface through which a consumer 126 can tip the producer 102). As noted herein, the computer readable reference code may be generated such that once received by a (consumer's) computing device, the computer readable reference code causes the computing device to be directed to an interface (e.g., application or web-based interface) through which an individual can send a monetary tip to the producer.

The product marking engine 106 may be configured to provide the computer readable reference code for marking on the product 108 to be eventually sold to the consumer 126. In some instances, the product marking engine 106 may generate a label that may be disposed on the outer packaging of the product 108.

Once the consumer 126 receives the product 108 through way to the vendor 116 (or by some other supply channel), the consumer 126 may enter the computer readable reference code marked on the product into their computing device to interface for tipping the producer 102. In some implementations, the computer readable reference code may be scanned by the vendor 116 (e.g., when the consumer 126 purchases the product 108 from the vendor 116), thereby prompting the vendor 116 accept the tip for the producer 102 in accordance with the techniques described in this paper in coordination with the transaction to purchase the product. In various implementations, the consumer 126 may enter the computer readable reference code into their device manually (e.g., alphanumeric character string) or by scanning the computer readable reference code (e.g., scanning the bar code using their hand-held computing device).

Upon receiving the computer readable reference code, the consumer's computing device may be directed to send a tip request to the server 120. The server 120, in response, may provide the consumer's computing device with an interface through which the consumer can enter information regarding the tip they wish to submit to the producer 102. As noted herein, tip information may include a tip amount to be submitted to the producer 102, a payment method for providing the tip to the producer 102, and/or enter a comment to the producer 102.

The financial processor 124 may be configured to receive the tip information from the consumer's computing device, process the information, and crediting the producer 102 with a tip in accordance with the information. In processing the tip information and crediting the producer 102 with the tip, the financial processor 124 may utilize such services as PayPal®, or a credit card company. The processing may result in a direct payment in the amount of the tip to the producer 102.

In some implementations, the system 100 may not submit a direct payment to the producer 102 upon processing the tip but, rather, credit the producer 102 with the tip and transfer funds to the producer 102 only once their account has reached a sufficient amount. In such instances, the system 100 may utilize the payment aggregation engine 122 to credit the producer's account (e.g., Pachamama Coffee Co-op) and transfer funds when the tip total for the producer 102 has reached a threshold (e.g., $100) The payment aggregation engine may or may not update the producer account data store (e.g., to indicate the aggregated amount of direct payments received for a producer). Alternatively, the payment aggregation engine may maintain its own data store with aggregated direct payments associated with producer IDs. The payment aggregation engine may or may not collect interest accrued during the aggregation process.

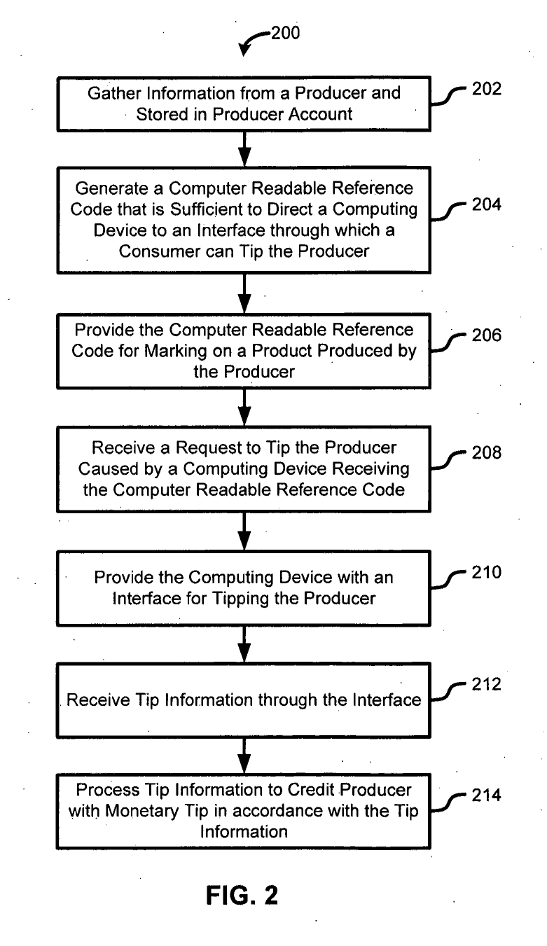

FIG. 2 depicts a flowchart of an example of a method 200 for tracking a product to enable tipping of a producer in accordance with some implementations. The method 200 begins with step 202, where information is gathered from the producer and stored in a producer account associated with the producer. In some embodiments, the gathered information may include the producer's organization type (e.g., co-op), the producer's geographic location, product type (e.g., coffee bean type), product origin (e.g., farm), product source (e.g., co-op, country, region, etc.), or production environment (e.g., altitude, coffee bean, farm size, annual crop, etc.).

At step 204, a compute readable reference code is generated in associated with the producer or a product associated with the producer. In some embodiments, the computer readable reference code may be stored in association with the producer's producer account. The computer readable reference code may be sufficient to direct a consumer's computing device to an interface through which a consumer can tip the producer. The consumer's computing device may be directed to the interface once the computer readable reference code is received by the computing device, possibly by manually entry or by scanning.

At step 206, the computer readable reference code generated in step 204 may be provided for marking the product. The product may be directly associated with the computer readable reference code, or may be associated with a producer that is directly associated with the computer readable reference code. Providing the computer readable reference code for product marking may involve generating a label comprising the computer readable reference code (e.g., the barcode).

Eventually, once the product is purchased by a consumer, the consumer enters the computer readable reference code into their computing device. According to some techniques described herein; this may direct the computing device to send a request to tip the producer. At step 208, this request to tip the producer is received. In response to the request, at step 210, an interface for tipping the producer is provided to the consumer's computing device. Through the interface, the consumer may enter information regarding the tip they wish to submit to the producer including, but in no way limited to, the tip amount, the payment method for the tip (PayPal®, credit card), and comments to be sent to the producer along with the tip.

At step 212, the tip information is received through the interface and processed at step 214. Upon processing tip information, funds from the tip may be transferred to the producer or may, alternatively, be aggregated until the tip amount meets a specific threshold.

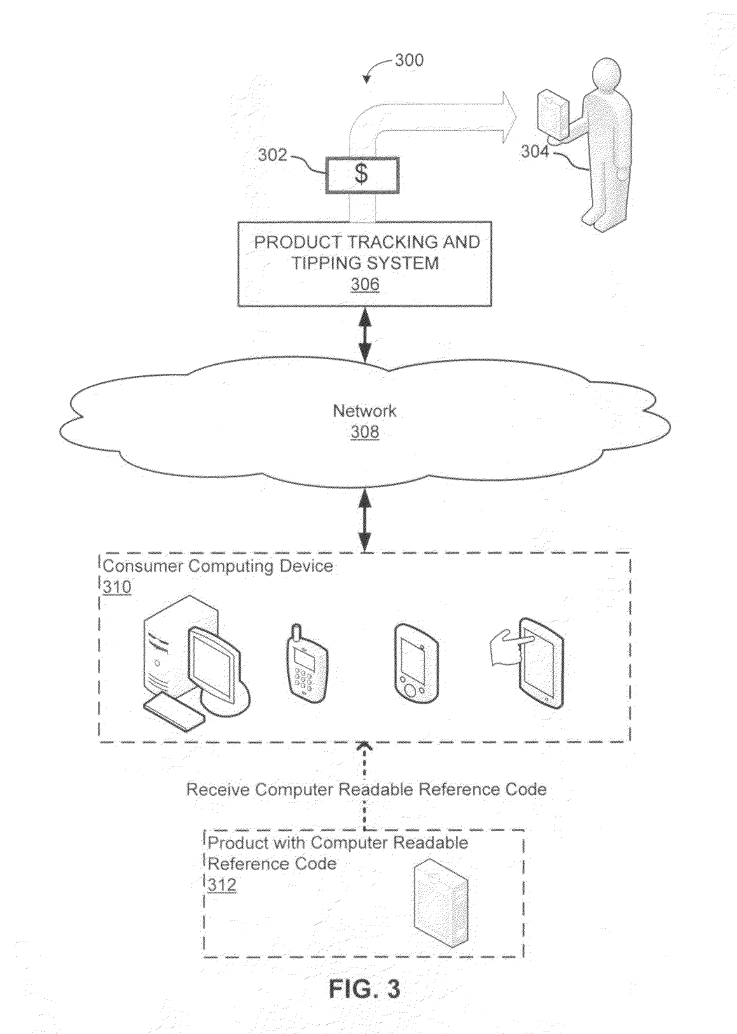

FIG. 3 depicts usage of an example of a system 306 for tracking a product to enable tipping of a producer 304 in accordance with some implementations. The system 306 may communicate with a consumer computing devices 310 over a network 308 (e.g., the Internet). Examples, of consumer computing devices 310 may include, desktop, laptops, smartphones, personal digital assistants (PDAs), tablets, and the like;

A product 312 that is registered with the system 306 (e.g., the product 312 or producer 304 of the product 312 is directly registered with the system 306) may have a computer readable, reference code disposed on its packaging. When a consumer has completed their purchase of the product 312, they utilize their consumer computing device 310 to receive the computer readable reference code, either through manual entry or through a scan process (e.g., smartphone camera takes a picture of the computer readable reference code). Upon receiving the computer readable reference code, the consumer-computing device 310 may submit a request to tip the producer 304 through the system 306. In turn, the system 306 may respond by providing an interface through which the consumer computing device 310 can enter the tip amount they desire to submit to the produce. In addition to the tip amount, the consumer may desire to enter a payment method for the tip, or a comment to be sent to the producer 304. Some implementations may also permit a consumer to request sharing news regarding the producer 304, product 312 or the payment of the tip on a social media account (e.g., using the consumer's social media account). Upon completion of processing the tip request, the producer 304 would be credited with the tip funds. For some implementations, actual transfer of funds 302 to the producer 304 may not take place until certain conditions are satisfied (e.g., total amount of tips credits meets a threshold).

Eventually, once conditions for tip payment have been met, the funds

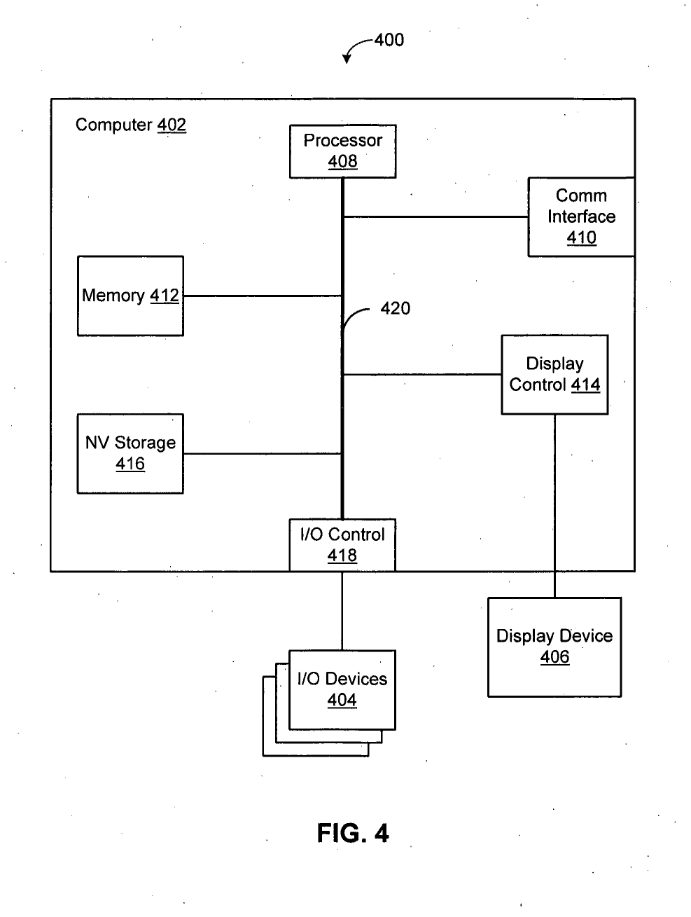

FIG. 4 depicts an example of a computer system on which implementations described in this paper can be implemented. A computer system (also referred to herein as a “computing device”) will usually include a processor, memory, non-volatile storage, and an interface. Peripheral devices can also be considered part of the computer system. A typical computer system will include at least a processor, memory, and a device (e.g., a bus) coupling the memory to the processor. The processor can include, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to one or more interfaces. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

In the case of FIG. 4, the computer system 400 may be a conventional computer system that can be used as a client computer system, such as a wireless client or a workstation, or a server computer system. The computer system 400 includes a computer 402, I/O devices 404, and a display device 406. The computer 402 includes a processor 408, a communications interface 410, memory 412, display controller 414, non-volatile storage 416, and I/O controller 418. The computer 402 may be coupled to or include the I/O devices 404 and display device 406.

The computer 402 interfaces to external systems through the communications interface 410, which may include a modem or network interface. It will be appreciated that the communications interface 410 can be considered to be part of the computer system 400 or a part of the computer 402. The communications interface 410 can be an analog modem, ISDN modem, cable modem, token ring interface, satellite transmission interface (e.g. “direct PC”), or other interfaces for coupling a computer system to other computer systems.

The processor 408 may be, for example, a conventional microprocessor such as an Intel® Pentium® microprocessor. The memory 412 is coupled to the processor 408 by a bus 470. The memory 412 can be Dynamic Random Access Memory (DRAM) and can also include Static RAM (SRAM). The bus 470 couples the processor 408 to the memory 412, also to the non-volatile storage 416, to the display controller 414, and to the I/O controller 418.

The I/O devices 404 can include a keyboard, disk drives, printers, a scanner, and other input and output devices, including a mouse or other pointing device. The display controller 414 may control in the conventional manner a display on the display device 406, which can, be, for example, a cathode ray tube (CRT) or liquid crystal display (LCD). The display controller 414 and the I/O controller 418 can be implemented with conventional well known technology.

The non-volatile storage 416 is often a magnetic hard disk, an optical disk, or another form of storage for large amounts of data. Some of this data is often written, by a direct memory access process, into memory 412 during execution of software in the computer 402. One of skill in the art will immediately recognize that the terms “machine-readable medium” or “computer-readable medium” includes any type of storage device that is accessible by the processor 408 and also encompasses a carrier wave that encodes a data signal.

The computer system 400 is one example of many possible computer systems which have different architectures. For example, personal computers based on an Intel microprocessor often have multiple buses, one of which can be an I/O bus for the peripherals and one that directly connects the processor 408 and the memory 412 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 412 for execution by the processor 408. A Web TV system, which is known in the art, is also considered to be a computer system, but it may lack some of the features shown in FIG. 4, such as certain input or output devices. A typical computer system will usually include at least a processor, memory, and a bus coupling the memory to the processor.

A networked system can include several network computer systems coupled together, such as a local area network (LAN), the Internet, or some other networked system. The term “Internet” as used in this paper refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. Applicable known or convenient physical connections of the Internet and the protocols and communication procedures of the Internet and the web are and/or can be used. A network can broadly include, as understood from relevant context, anything from a minimalist coupling of the components illustrated in the example of FIG. 1, to every component of the Internet and networks coupled to the Internet.

Networks can include enterprise private networks and virtual private networks (collectively, private networks). As the name suggests, private networks are under the control of an entity rather than being open to the public. Private networks include a head office and optional regional offices (collectively, offices). Many offices enable remote users to connect to the private network offices via some other network, such as the Internet. In the example of FIG. 1, certain components may be part of a first private network, while other components are part of some other network. For example, the components 104, 110, 112, 118, 120, and 122 and could be part of a first private network (e.g., at a producer-tipping aggregation site); the components 106 and 114 could be part of a second private network (e.g., at the producer). Some components may be located in two different locations. For instance, a producer could have the ID assignment engine and a producer-tipping aggregation site could also have an ID assignment engine (or one of the engines could be designated an ID generation engine, capable of generating IDs, but not an ID assignment engine, since it lacks authority to actually assign IDs). The ID assignment engines could produce the same IDs at either location, or could coordinate to ensure IDs are unique.

Some computer systems are implied in FIG. 1. For example, the producer provides data to the producer information generation engine 104. This can include the producer entering data in a client machine for processing at a server coupled to the producer information generation engine 104. Similarly, the vender and/or consumer can include a client machine for communicating with the server and/or the financial processor.

Some portions of the description of FIG. 1 may be presented in terms of algorithms. These algorithmic descriptions are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms presented herein are not inherently related to any particular computer or other apparatus. Various general purpose systems may be used with programs to configure the general purpose systems in a specific manner as specifically purposed computer systems, or it may prove convenient to construct specialized apparatus to perform the methods of some implementations.

Implementations described in this paper relate to apparatus for performing the operations. The apparatus can be specially constructed for the required purposes, or it can comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

Although the foregoing implementations have been described in some detail for purposes of clarity of understanding, the invention is not necessarily limited to the details provided.

What is claimed is:

1. A system for tracking a product and tipping a producer of a product, the comprising:
a reference code assignment engine configured to generate a computer readable reference code and associate the computer readable reference code with a producer, wherein the computer readable reference code is configured such that when received by a computing device, the computer readable reference code directs the computing device to an interface through which an individual can send a monetary tip to the producer;
a product marking engine configured to provide the computer readable reference code for marking on a product associated with the producer;
a server configured to:
receive, from a requesting computing device, a request to monetarily tip the producer, wherein the request is generated as a result of the requesting computing device receiving the computer readable reference code,
provide the requesting computing device with the interface through which the individual can send a monetary tip to the producer, and
receive tip information from the requesting computing device through the interface; and
a financial processor configured to process the tip information and credit the producer with a monetary tip in accordance with the tip information.

2. The system of claim 1, wherein generating the computer readable reference code in association with the producer comprises generating the computer readable reference code in association with a particular product associated with the producer.

3. The system of claim 2, wherein the computer readable reference code generated in association with the particular product is unique to the particular product, a retailer offering the particular product, or packaging of the particular product.

4. The system of claim 1, further comprising:
a producer information generation engine configured to gather information regarding the producer or regarding the product produced by the producer, wherein the computer readable reference code is generated based on the gathered information.

5. The system of claim 1, further comprising:
a producer information generation engine configured to gather information regarding the producer or regarding the product produced by the producer; and
a producer account datastore configured to store the gathered information in a producer account associated with the producer, wherein information in the producer account is used to provide the interface through which the individual can send the monetary tip to the producer or used to process the tip information from the requesting computing device.

6. The system of claim 5, wherein the gathered information includes information regarding producer organization, producer geographic location, producer geographic location, product origin, product manufacturing process, or production environment.

7. The system of claim 1, wherein the computer readable reference code is an image, a barcode or an alphanumeric character string.

8. The system of claim 1, further comprising:
a payment aggregation engine configured to aggregate, in a tip account, the monetary tip credited to the producer, and transfer funds from the tip account to the producer when the tip account reaches a predetermined amount.

9. A method for tracking a product and tipping a producer of a product, the comprising:
generating a computer readable reference code in association with a producer, wherein the computer readable reference code is configured such that when received by a computing device, the computer readable reference code directs the computing device to an interface through which an individual can send a monetary tip to the producer;
providing the computer readable reference code for marking on a product associated with the producer;
receiving, from a requesting computing device, a request to monetarily tip the producer, wherein the request is generated as a result of the requesting computing device receiving the computer readable reference code;
providing the requesting computing device with the interface through which the individual can send a monetary tip to the producer;
receiving tip information from the requesting computing device through the interface; and
processing the tip information and crediting the producer with a monetary tip in accordance with the tip information.

10. The method of claim 9, wherein generating the computer readable reference code in association with the producer comprises generating the computer readable reference code in association with a particular product associated with the producer.

11. The method of claim 10, wherein the computer readable reference code generated in association with the particular product is unique to the particular product, a retailer offering the particular product, or packaging of the particular product.

12. The method of claim 9, further comprising:
gathering information regarding the producer or regarding the product produced by the producer, wherein the computer readable reference code is generated based on the gathered information.

13. The method of claim 9, further comprising:
gathering information regarding the producer or regarding the product produced by the producer; and
storing the gathered information in a producer account associated with the producer, wherein information in the producer account is used to provide the interface through which the individual can send the monetary tip to the producer or used to process the tip information from the requesting computing device.

14. The method of claim 13, wherein the gathered information includes information regarding producer organization, producer geographic location, producer geographic location, product origin, product manufacturing process, or production environment.

15. The method of claim 9, wherein the computer readable reference code is an image, a barcode or an alphanumeric character string.

16. The method of claim 9, further comprising:
aggregating, in a tip account, the monetary tip credited to the producer; and
transferring funds from the tip account to the producer when the tip account reaches a predetermined amount.

17. A system for tracking a product and tipping a producer of a product, the comprising:
means for generating a computer readable reference code in association with a producer, wherein the computer readable reference code is configured such that when received by a computing device, the computer readable reference code directs the computing device to an interface through which an individual can send a monetary tip to the producer;
means for providing the computer readable reference code for marking on a product associated with the producer;
means for receiving, from a requesting computing device, a request to monetarily tip the producer, wherein the request is generated as a result of the requesting computing device receiving the computer readable reference code;
means for providing the requesting computing device with the interface through which the individual can send a monetary tip to the producer;
means for receiving tip information from the requesting computing device through the interface; and
means for processing the tip information and crediting the producer with a monetary tip in accordance with the tip information.
